(19) United States
(12) Patent Application Publication
(10) Pub. No.: US 2025/0049044 A1
(43) Pub. Date: Feb. 13, 2025

(54) Rolling Dough Mat Device

(71) Applicant: Carolyn Wommack, Louisiana, MO (US)

(72) Inventor: Carolyn Wommack, Louisiana, MO (US)

(21) Appl. No.: 18/787,068

(22) Filed: Jul. 29, 2024

Related U.S. Application Data
(60) Provisional application No. 63/518,369, filed on Aug. 9, 2023.

(51) Int. Cl. A21C 9/08; A21C 3/02

(52) U.S. Cl. CPC A21C 9/083; A21C 3/021

(57) ABSTRACT

A rolling dough mat or tray device for rolling dough securely and safely without spilling flour and other ingredients such as butter, eggs, and more on a countertop and floor is disclosed. The device includes a planar member and a raised wall extending along or around an edge of the planar member. The raised walls extend at an angle that departs away from the horizontal plane of the planar member and each wall is beveled. The raised walls function as a barrier for the flour and other ingredients from spilling out of the device onto the countertop or floor. In different embodiments, the device has a logo for marketing, a QR code encoded with dough recipes, and a plurality of measurement guides for assessing different rolled dough sizes. The device is made of food-grade material and can include an anti-bacterial coating.

### CROSS-REFERENCE TO RELATED APPLICATION

The present application claims priority to, and the benefit of, U.S. Provisional Application No. 63/518,369, which was filed on Aug. 9, 2023 and is incorporated herein by reference in its entirety.

### FIELD OF THE INVENTION

The present invention generally relates to the field of kitchen accessory devices. More specifically, the present invention relates to a novel rolling dough tray or mat device for rolling dough without spilling flour and other ingredients on the countertop and floor of the cooking or baking area. The device includes a food-grade planar member having raised walls extending from the edges of the planar member. The mat grips the surface it is placed on to prevent the device from moving while rolling the dough. The device can be used with any rolling pin or other rolling devices. The raised walls function as barrier for the flour and the other ingredients to prevent them from spilling out of the device. Accordingly, the present disclosure makes specific reference thereto. Nonetheless, it is to be appreciated that aspects of the present invention are also equally applicable to other like applications, devices, and methods of manufacture.

### BACKGROUND

By way of background, rolling dough is a common activity for chefs, bakers, and other individuals. Rolling dough is required for making cookies, pies, pizzas, pastries, and more. Generally, a rolling pin which is a cylindrical food preparation utensil is used to shape and flatten dough on a flat surface. Rolling dough often involves stretching and folding the dough repeatedly. Accordingly, rolling dough needs a large, clear surface to maneuver comfortably and apply even pressure. The amount of space needed for rolling dough depends on the recipe and the preference of a baker.

While rolling dough, flour dusts and spills as an individual rolls, and bits of dough can tear off and fall. Flour is also often sprinkled on the surface and on the dough to prevent sticking. Other ingredients like butter or egg yolk also spill on the countertop and floor. Considerable effort and time are spent to clean the countertop after rolling dough to maintain cleanliness and safety. Sanitization of the countertop with a food-safe disinfectant or a bleach solution is not always possible. Kitchen countertops often become breeding grounds for bacteria and germs, especially when food particles are left behind and such bacteria and germs can contaminate the dough. People desire a mat device that functions as a rolling dough surface and prevents spilling of dough and other ingredients on countertops and floor.

Therefore, there exists a long felt need in the art for an improved device that eliminates rolling dough on kitchen countertops and floors. There is also a long felt need in the art for a kitchen utensil that can be used for rolling dough safely without spilling flour and other items on countertopss. Additionally, there is a long felt need in the art for a novel rolling dough mat device that can be placed on any surface for rolling dough using a rolling pin or any other similar device. Moreover, there is a long felt need in the art for a multifunctional rolling dough device that helps prevent excessive mess when rolling out dough by preventing spilling of flour on countertopss. Further, there is a long felt need in the art for a device that improves sanitization and cleanliness in rolling dough. Furthermore, there is a long felt need in the art for a device that provides a dedicated space and surface for rolling dough for different items and dishes. Finally, there is a long felt need in the art for a mat device that can be used in both personal and professional kitchens to reduce mess caused due to spilling of ingredients and to save time in clean-up activities after rolling dough.

The subject matter disclosed and claimed herein, in one embodiment thereof, comprises a rolling dough mat device for rolling dough safely without spilling flour and other ingredients on a countertop or floor. The rolling dough mat device is portable and includes a planar member which has a bottom surface equipped with anti-slipping ridges and a top surface adapted to function as a rolling area for dough. The bottom surface does not slip on any surface and therefore provides a stable rolling dough operation. A raised wall is disposed along each edge of the planar member, each raised wall is beveled and extends upwards at an angle ranging between 120 degrees and 160 degrees that departs away from the horizontal plane of the planar member. The extended walls provide a barrier to prevent flour and other ingredients from spilling onto the countertop or floor. The device can have a logo and one or more measurement guides for rolling dough to specific diameters.

In this manner, the rolling dough mat device of the present invention accomplishes all of the forgoing objectives and provides users with a mat designed to help prevent excessive mess when rolling out dough. The raised walls contain all ingredients (e.g., flour) within the mat and prevent it from spilling on the countertop and floor. The raised walls are designed not to obstruct the rolling dough process and the mat device helps in reducing the cleanup time after rolling dough. The device remains stable during use and can be easily cleaned for cleanliness and sanitization.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rolling dough mat device designed to help prevent rolling dough directly on a countertop or floor. The rolling dough mat device further comprising a planar member which has a bottom surface equipped with anti-slipping ridges and a top surface adapted to function as a rolling area. A raised wall is disposed along each edge of the planar member, each raised wall is beveled and extends upwards at an angle that departs away from the horizontal plane of the planar member. The walls provide a barrier to prevent flour, eggs, and other ingredients from spilling onto the countertop or floor during the rolling of dough on the top surface of the mat device.

In another aspect, a device configured to help roll dough is disclosed. The device is adapted to be placed on a surface such as a countertop for rolling dough. The device includes a planar member having a front end and an opposite rear end, a left side and an opposite right side. The top surface of the planar member has an antibacterial coating and is used for rolling dough. A beveled raised wall is disposed at each of the front end, rear end, left side, and right side of the planar member, each raised wall extends upwards at from 120 degree to 150 degree angle that departs from the horizontal plane of the planar member.

In another embodiment, a rolling dough tray is disclosed. The tray includes a planar member having a front end and an opposite rear end, a left side and an opposite right side. A raised wall is disposed at each of the front end, rear end, left side, and right side of the planar member, each raised wall has a width of two inches and extends upwards at an angle that departs from the horizontal plane of the planar member. The walls do not obstruct the rolling dough operation while preventing the flour and other ingredient from spilling out of the tray.

In another embodiment of the present invention, the rolling dough mat prevents flour, eggs, and other ingredients spilling on countertops on which the mat is placed. The rolling dough mat is made of food-grade plastic or food-grade silicone and includes, for example, dimensions of 18″×18″, 12″×12″, and 24″×24″.

In yet another embodiment, the top surface of the rolling dough mat device has embedded measurement guides for rolling dough to specific diameters, and a QR code for providing access to a plurality of encoded dough recipes.

In a further embodiment, the device includes a scraper device groove integrated into one of the raised walls for holding a scraper device used for cleaning the mat after use.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the rolling dough mat device of the present invention in accordance with the disclosed architecture;

FIG. 2 illustrates a perspective view showing a user rolling dough using the rolling dough mat device of the present invention in accordance with the disclosed structure; and

FIG. 3 illustrates a top view of another embodiment of the rolling dough mat device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved device that eliminates rolling dough on kitchen countertops and floors. There is also a long felt need in the art for a kitchen utensil that can be used for rolling dough safely without spilling flour and other items on countertops. Additionally, there is a long felt need in the art for a novel rolling dough mat device that can be placed on any surface for rolling dough using a rolling pin or any other similar device. Moreover, there is a long felt need in the art for a multifunctional rolling dough device that helps prevent excessive mess when rolling out dough by preventing spilling of flour on countertops. Further, there is a long felt need in the art for a device that improves sanitization and cleanliness in rolling dough. Furthermore, there is a long felt need in the art for a device that provides a dedicated space and surface for rolling dough for different items and dishes. Finally, there is a long felt need in the art for a mat device that can be used in both personal and professional kitchens to reduce mess caused due to spilling of ingredients and to save time in clean-up activities after rolling dough.

The present invention, in one exemplary embodiment, is a kitchen accessory portable device to help an individual to roll dough securely without spilling flour and other ingredients on the countertop and floor. The device is adapted to be placed on a surface such as countertop for rolling dough. The device includes a planar member having a front end and an opposite rear end, a left side, and an opposite right side. The top surface of the planar member has an antibacterial coating and is used for rolling dough. A beveled raised wall is disposed at each of the front end, rear end, left side, and right side of the planar member, each raised wall extends upwards at from a 120 to 150 degree angle that departs from the horizontal plane of the planar member. The device is washable and reusable and can come in different sizes to roll dough of different diameters and sizes.

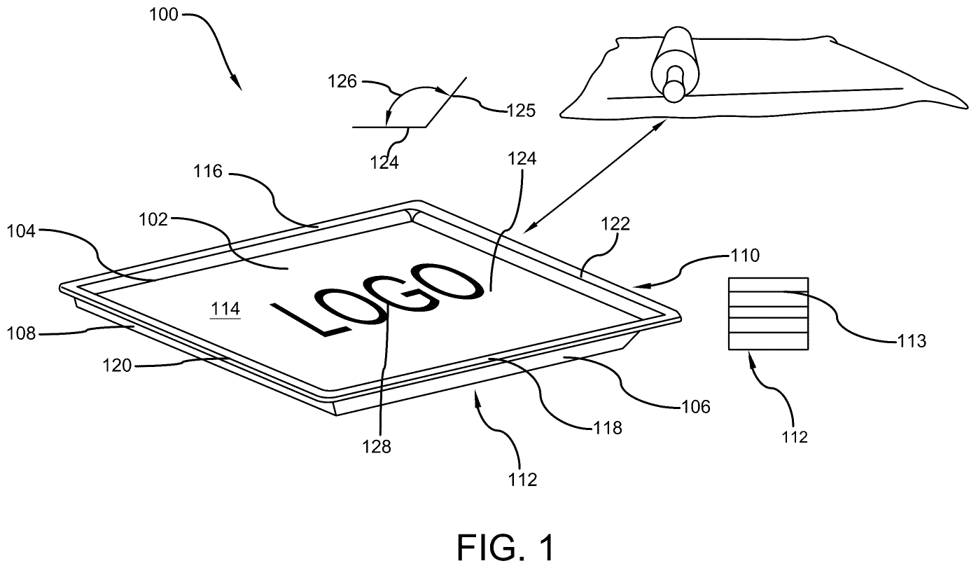

Referring initially to the drawings, FIG. 1 illustrates a perspective view of the rolling dough mat device of the present invention in accordance with the disclosed architecture. The rolling dough mat device 100 of the present invention is designed to make the process of rolling dough cleaner and more convenient. The rolling dough mat device 100 prevents rolling dough on a floor or countertop of a kitchen, thereby eliminating spilling of flour and other materials onto the floor. More specifically, the rolling dough mat device 100 has a planar member 102 having a front end 104 and an opposite rear end 106. The planar member 102 is generally rectangular or square (i.e., rectilinear) including a left side 108 and an opposite right side 110.

The bottom surface 112 of the planar member 102 has anti-slipping ridges 113 for preventing slipping of the mat device 100 during rolling dough. The top surface 114 of the planar member 102 is adapted to function like a floor for rolling dough easily. A raised wall is disposed along each side of the planar member 102 for acting as a barrier to prevent flour and other ingredients used in dough making from spilling onto the countertop or floor. As illustrated, a first raised wall 116 is disposed at the front end 104 of the planar member 102, a second raised wall 118 is disposed at the rear end 106 of the planar member 102, a third raised wall 120 is disposed at the left side 108 of the planar member 102 and a fourth raised wall 122 is disposed at the right side 110 of the planar member 102.

Each raised wall 116, 118, 120, 122 of the rolling dough tray 100 is beveled and departs from a horizontal plane 124 of the planar member 102. Further, each raised wall 116, 118, 120, 122 extends upwards (shown by plane 125) at an angle 126 that departs from the horizontal plane 124. In preferred embodiment, the angle for each raised wall is from 120 degrees to 150 degrees from the planar member 102. In other embodiments, the angle 126 from the horizontal plane 124 can range from about 120 degrees to about 165 degrees. Each raised wall 116, 118, 120, 122 can have a height (Arrow A) from about 1.0 inch to about 2.0 inches, thereby providing barrier to flour from spilling while not obstructing the rolling process on the planar member 102. The beveled design ensures that the raised walls are not too sharp or intrusive, allowing for comfortable use.

In the preferred embodiment, the rolling dough tray 100 has a size, for example, of 18″×18″ (i.e., rectilinear) including the raised walls. In other embodiments, the rolling dough mat device 100 can have a size of 24″×24″ (i.e., rectilinear) for providing a larger surface area for rolling dough. It is to be appreciated that the rolling dough mat device can be curvilinear or circular. The mat device 100 is made of food grade material (i.e., food-grade silicone) which is durable, has non-stick properties, and can be cleaned easily. Preferably, the mat device 100 is made of food-grade silicone or plastic material. The mat device 100 can have different colors and designs and can also have a logo or indicia 128 on the top surface 114 for branding and marketing purposes.

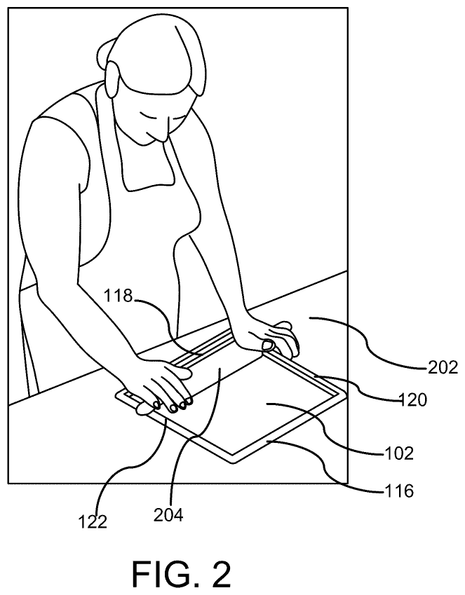

FIG. 2 illustrates a perspective view showing a user rolling dough using the rolling dough mat device of the present invention in accordance with the disclosed structure. The planar member 102 of the rolling dough mat device 100 can be placed on a countertop of a kitchen or any other surface 202 and can be used for rolling dough using a rolling pin 204 or any other similar device. The top surface 114 functions as a floured work surface and the raised walls 116, 118, 120, 122 support the arms 206 of a user while preventing the flour, eggs, and other materials from spilling onto the countertop or floor. The mat device 100 can be maneuvered easily and can be used for making different types of dishes. The mat device 100 can also be used for chopping fruits and vegetables in addition to rolling dough.

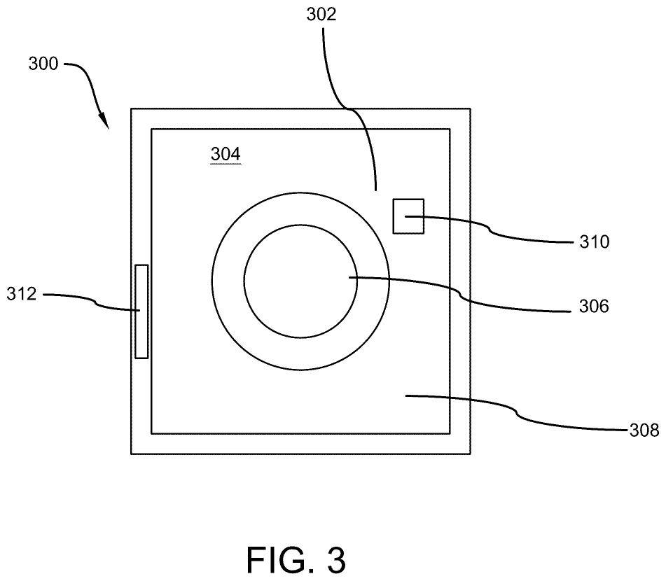

FIG. 3 illustrates a top view of another embodiment of the rolling dough mat device of the present invention in accordance with the disclosed structure. In the present embodiment, the top surface 304 of the planar member 302 has embedded measurement guides 306 for rolling dough to specific diameters which can be helpful for rolling dough for pizzas, pies and more. A QR code 308 can be disposed on the top surface 304 for scanning using an image sensor. The QR code 308 can be static or dynamic and can have a plurality of encoded dough recipes.

The top surface 304 can also be coated with an antibacterial coating 310 for preventing growth of molds and bacteria during use of the mat device 300. A scraper device groove 312 is disposed in one of the raised walls for holding the scraper device used for scraping the flour from the mat device 300 after use of the device 300. In one embodiment, for securing the rolling dough mat 100, 300 to a surface, a plurality of suction cups can be disposed on the bottom surface of the planar member 102. In other embodiments, the rolling dough mat 100, 300 can be fastened to a countertop or floor to meet preferences of different users.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rolling dough mat device”, “rolling dough mat”, “rolling dough tray”, “mat device”, and “device” are interchangeable and refer to the rolling dough mat device 100, 300 of the present invention.

Notwithstanding the forgoing, the rolling dough mat device 100, 300 of the present invention can be of any suitable size and configuration as is known in the art without affecting the overall concept of the invention, provided that it accomplishes the above stated objectives. One of ordinary skill in the art will appreciate that the rolling dough mat device 100, 300 as shown in the FIGS. are for illustrative purposes only, and that many other sizes and shapes of the rolling dough mat device 100, 300 are well within the scope of the present disclosure. Although the dimensions of the rolling dough mat device 100, 300 are important design parameters for user convenience, the rolling dough mat device 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rolling dough mat device for rolling dough comprising:
a planar member;
a top surface;
a bottom surface;
a peripheral edge; and
a raised wall;
wherein said bottom surface including a plurality of anti-slipping ridges;
wherein said raised wall disposed around said peripheral edge;
wherein said raised wall departs upward at an angle from a horizontal plane of said planar member; and
further wherein said angle is from 120 degrees to 165 degrees.

2. The rolling dough mat device for rolling dough of claim 1, wherein said raised wall having a height from 1.0 inch to 2.0 inches.

3. The rolling dough mat device for rolling dough of claim 2, wherein said rolling dough mat device having a material of food-grade silicone.

4. The rolling dough mat device for rolling dough of claim 3, wherein said raised wall is beveled.

5. The rolling dough mat device for rolling dough of claim 4, wherein said angle is from 120 degrees to 150 degrees.

6. The rolling dough mat device for rolling dough of claim 5, wherein said peripheral edge is rectilinear.

7. The rolling dough mat device for rolling dough of claim 6, wherein said planar surface is from 12″×12″ to 24″×24″.

8. The rolling dough mat device for rolling dough of claim 7, wherein said raised wall having a first raised portion disposed at a front end of said planar member, a second raised portion disposed at a rear end of said planar member, a third raised portion disposed at a left side of said planar member, and a fourth raised portion disposed at a right side of said planar member.

9. The rolling dough mat device for rolling dough of claim 5, wherein said peripheral edge is curvilinear.

10. A rolling dough mat device for rolling dough comprising:
a planar member;
a top surface;
a bottom surface;
a peripheral edge; and
a raised wall;
wherein said raised wall disposed around said peripheral edge;
wherein said raised wall departs upward at an angle from a horizontal plane of said planar member;
wherein said peripheral edge is rectilinear; and
further wherein said angle is from 120 degrees to 165 degrees.

11. The rolling dough mat device for rolling dough of claim 10, wherein said raised wall having a height from 1.0 inch to 2.0 inches.

12. The rolling dough mat device for rolling dough of claim 11, wherein said rolling dough mat device having a material of food-grade silicone.

13. The rolling dough mat device for rolling dough of claim 12, wherein said raised wall is beveled.

14. The rolling dough mat device for rolling dough of claim 13, wherein said angle is from 120 degrees to 150 degrees.

15. The rolling dough mat device for rolling dough of claim 12, wherein said planar surface is from 12″×12″ to 24″×24″.

16. The rolling dough mat device for rolling dough of claim 15, wherein said raised wall having a first raised portion disposed at a front end of said planar member, a second raised portion disposed at a rear end of said planar member, a third raised portion disposed at a left side of said planar member, and a fourth raised portion disposed at a right side of said planar member.

17. The rolling dough mat device for rolling dough of claim 16, wherein said bottom surface including a plurality of anti-slipping ridges.

18. A rolling dough mat device for rolling dough comprising:
a planar member;
a top surface;
a bottom surface;
a peripheral edge; and
a raised wall;
wherein said raised wall disposed around said peripheral edge;
wherein said raised wall departs upward at an angle from a horizontal plane of said planar member;
wherein said planar member having a measurement guide centered therein;
wherein said peripheral edge is rectilinear; and
further wherein said angle is from 120 degrees to 165 degrees.

19. The rolling dough mat device for rolling dough of claim 18, wherein said raised wall having a height from 1.0 inch to 2.0 inches.

20. The rolling dough mat device for rolling dough of claim 19, wherein said bottom surface having a plurality of suction cups for securing to a countertop.
